(19) United States
(12) Patent Application Publication
(10) Pub. No.: US 2025/0389387 A1
(43) Pub. Date: Dec. 25, 2025

(54) TANK FOR PRESSURIZED GAS

(71) Applicant: Faurecia Hydrogen Solutions France, NANTERRE (FR)

(72) Inventors: Christophe BAVEREL, AUDINCOURT (FR); Gaëtan RICHARD, BELFORT (FR); Thomas FERRIER, MONTBELIARD (FR); David FARALDI, MONTBELIARD (FR)

(21) Appl. No.: 19/243,821

(22) Filed: Jun. 20, 2025

(30) Foreign Application Priority Data
Jun. 24, 2024 (FR) 24 06780

(51) Int. Cl. F17C 1/16; B29D 22/00

(52) U.S. Cl. CPC F17C 1/16; B29D 22/003; F17C 2201/0166; F17C 2203/0604; F17C 2203/0619; F17C 2203/0673; F17C 2209/2118; F17C 2209/2154; F17C 2209/232

(57) ABSTRACT

A tank for pressurized gas, in particular hydrogen, comprises a composite structure and a liner. The liner comprises at least two parallel tubes extending substantially along a first direction. At each end of the tubes, a common end shell sealingly closes all the tubes. The composite structure comprises an elementary structure around each tube, and an overall structure around an assembly of the tubes and end shells. A method for producing such a tank is also disclosed.

### CROSS-REFERENCE TO RELATED APPLICATION

This application is a U.S. non-provisional application claiming the benefit of French Application No. 24 06780, filed on Jun. 24, 2024, which is incorporated herein by reference in its entirety.

### TECHNICAL FIELD

The disclosure relates to a tank for storing pressurized gas.

### BACKGROUND

A pressurized gas tank is typically used to carry a gas on board a vehicle. The storage pressure of said gas can be high, up to pressures of the order of 1000 bar.

The gas is, for example, hydrogen intended for the propulsion of said vehicle, either by direct combustion in a hydrogen engine, or by electricity production within a fuel cell.

A tank of this type must be light enough to withstand the pressures involved, so as not to cut into the vehicle's weight budget. It is also known that such a tank is made of a composite material. A known embodiment uses a composite structure comprising fibers embedded in a resin matrix. This structure acts as a framework for the tank, guaranteeing its shape and holding up to mechanical stresses. However, such a material cannot be gas-tight. The entire inner surface of the structure is thus lined with a thermoplastic liner, to make it gas-tight.

For the purposes of integrating the tank into a vehicle, it is advantageous for the tank to have a flattened shape. A spherical or cylindrical shape is most likely to offer uniform resistance to the mechanical stresses caused by pressure. A flattened shape, on the other hand, generates greater mechanical stress the further you move away from the spherical shape.

Embodiments are thus sought to obtain a flattened tank.

### SUMMARY

The disclosure offers an ingenious solution to this problem, using parallel tubes and an ingenious embodiment of the structure.

To this end, the disclosure comprises a tank for pressurized gas, in particular hydrogen, comprising a composite structure and a liner, where the liner comprises at least two parallel tubes extending substantially along a first direction, and at each end of the tubes a common end shell that sealingly closes all the tubes, and in that the composite structure comprises an elementary structure around each tube and an overall structure around an assembly of tubes and end shells.

Particular features or embodiments, usable alone or in combination, are:
the tubes are made by extrusion;
the end shells are injection-molded;
the end shells are welded to the tube ends;
the elementary structure is produced by filament winding around each tube and/or the overall structure is produced by filament winding around the assembly of tubes and end shells;
the liner further comprises an intermediate piece, taking the shape of the cross-section of the tube assembly, inserted and welded between the end of the tubes and an end shell;
one end tube has a partially circular cross-section, preferably substantially D-shaped;
an intermediate tube has an oblong cross-section, preferably rectangular with rounded corners.

A method for manufacturing a tank for pressurized gas, in particular hydrogen, comprising a composite structure and a liner is also disclosed. The method comprises the following steps:
manufacturing a plurality of tubes by extrusion, the plurality of tubes comprising two end tubes and at least zero intermediate tubes;
creating an elementary structure around each tube by filament winding;
parallel assembling of the plurality of tubes;
welding an end shell to each tube end, preferably by inserting an intermediate piece;
creating an overall structure around the assembly of tubes and end shells by filament winding.

### BRIEF DESCRIPTION OF THE DRAWINGS

The disclosure will be better understood on reading the following description, given solely by way of example, and with reference to the appended figures in which:

FIG. 1 shows, in exploded perspective view, a first end of a tank according to the disclosure;

FIG. 2 shows, in exploded perspective view, the other end of the tank of FIG. 1;

FIG. 3 shows a sectional view of the assembled tank shown in FIG. 1, in a plane passing through the X-axes of the tubes; and

FIG. 4 shows, in perspective view, a completed tank.

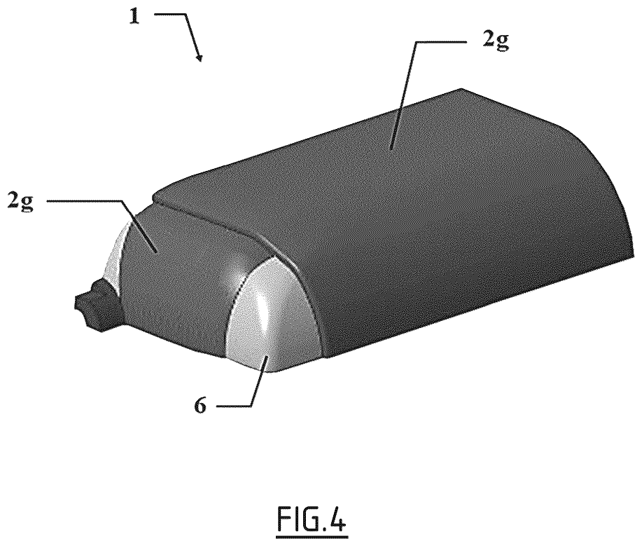

### DETAILED DESCRIPTION

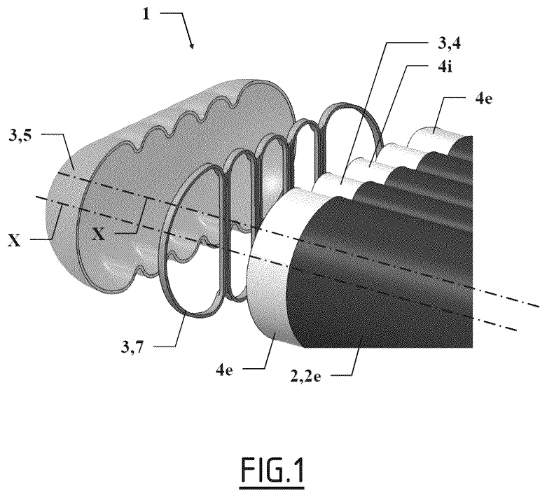

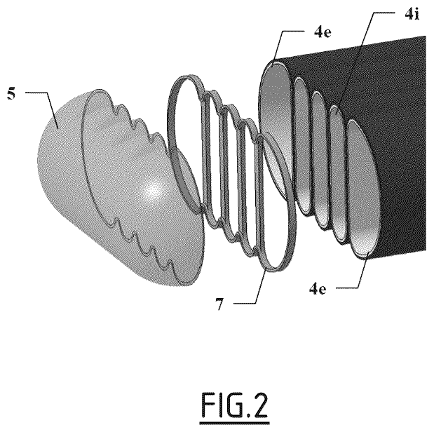

Referring to FIGS. 1 to 3, the disclosure relates to a tank 1 for pressurized gas, in particular hydrogen.

In order to withstand the high pressures imposed by the gas, the tank 1 comprises a structure 2. In order to limit weight and make it easier to fit on board a vehicle, this structure 2 is preferably made of composite material. In order to ensure a gas-tight seal, which the structure 2 cannot provide, particularly in the case of hydrogen, which has a very small molecule, the tank 1 further comprises a liner 3.

In an ingenious feature, the liner 3 comprises at least two parallel tubes 4 extending substantially along a first direction X. The liner 3 also comprises two end shells 5, 6. At each end of the tubes 4, an end shell 5, 6, common to all the tubes 4, seals all the tubes 4. According to this same feature, the structure 2 comprises an elementary structure 2e around each tube 4, and an overall structure 2g around the assembly of tubes 4 and end shells 5, 6.

According to another feature, the tubes 4 are produced by extrusion. This feature is particularly advantageous, as extrusion makes it easy to industrially produce a part by the meter, of any cross-section and any length. It will be seen later that an elementary structure 2e, surrounding a tube 4, can also be produced on request, to any desired length. This means that tubes 4, and hence tanks 1, of any length can be produced simply and industrially by extrusion.

Another feature is that the end shells 5, 6 are injection-molded.

In order to ensure the desired gas-tightness, the liner 3 and therefore all its components 4, 5, 6, 7, 8 are advantageously made of thermoplastic material, such as PA6 or any other plastic material of this type.

Another feature is that the end shells 5, 6 are welded to the ends of the tubes 4.

The reference sign 2 designates the structure generically, as well as all its parts 2e and 2g.

Another feature is that the structure 2 is produced in two successive layers. On the one hand, an elementary structure 2e is produced by winding filaments around each individual tube 4. The elementary structure 2e is produced by winding the tube 4 around the X axis by tilting the reel+/−α° relative to the X axis, a being between 45° and 90°, preferably between 80° and 90°, so as to cross the filaments. The reel is evenly offset along the length of tube 4 in relation to the X axis, so that it covers the tube 4 over virtually its entire length.

Filament winding is a well-known composite manufacturing technique. It consists in winding a filament, such as a wire, strip, etc., made of fibers, generally glass or carbon, around a form, mold or tube 4, coated with a thermosetting or thermoplastic resin in uncured form during winding, and then curing it.

Once each tube 4 has been fitted with its elementary structure 2e by filament winding, all the tubes 4 are joined together. They are closed by end shells 5, 6. The assembly comprising tubes 4 and end shells 5, 6 receives an overall structure 2g produced by filament winding around the assembly of tubes 4 and end shells 5, 6.

The overall structure 2g is produced by winding around the assembly comprising tubes 4 and shells 5, 6 welded to tubes 4. Winding then takes place along the two directions of the plane of the tank 1: X axis and Y axis. The overall structure 2g covers the entire tank 1 and in particular the shells 5, 6 not covered by the elementary structures 2e. At the elementary structures 2e, the overall structure 2g forms a second composite layer.

The shells 5, 6 are preferably assembled to the ends of the tubes 4 by welding. This welding can be carried out using any welding technology, preferentially autogenous welding.

Direct welding can be challenging because of the constraints inherent in the injection molding of the shells 5 and 6. Also, according to another feature, the liner 3 further comprises an intermediate piece 7, 8. This intermediate piece 7, 8 is substantially flat and substantially takes up the cross-sectional shape of the assembly of tubes 4. Such an intermediate piece 7 is inserted and welded between a first end of the tubes 4 and a first end shell 5. A further intermediate piece 8 is inserted and welded between the other end of the tubes 4 and a second end shell 6.

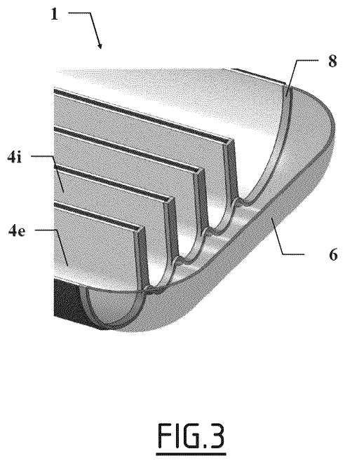

The profile of an intermediate piece 7, 8, more particularly visible in FIG. 3, is designed to join the walls of two adjacent tubes 4 on the tube side 4 and seal them, and to connect sealingly to the edge of the end shell 5, 6 on the end shell side. One objective is to have a continuous, closed thickness of the liner 3.

The tubes, generically referred to as 4, are distinguished into end tubes 4e, arranged on either side of the stack of tubes 4, along the Y axis, and “n” intermediate tubes 4i arranged between the end tubes 4e. “n” is a positive integer or zero. The choice of “n” allows the width of tank 1 to be determined at will.

A tube 4, 4e, 4i may have any cross-section. This cross-section is substantially constant along the X axis of tube 4. A circular cross-section is the most pressure-resistant. A rectangular cross-section optimizes the useful gas volume. However, overly pronounced edges can create damaging fractures and are therefore avoided.

Thus, in order to optimize the filling volume, according to another feature, an intermediate tube 4i has an oblong cross-section, preferably rectangular with rounded corners. The pressure resistance of an intermediate tube 4i is also ensured by the two adjacent tubes 4.

On the contrary, to optimize pressure resistance, according to another feature, an end tube 4e has a partially circular cross-section, on the side where the tube 4e is free of neighbors and substantially straight on the side where it is adjacent to an adjacent tube 4. An end tube 4e therefore preferably has a substantially “D-shaped” cross-section. Here too, to avoid fracturing, the two edges appearing at the two corners of the “D” are advantageously rounded.

The disclosure also relates to a method of manufacturing a tank 1 for pressurized gases, in particular hydrogen, comprising a composite structure 2 and a liner 3.

Such a method comprises the following steps. In a first step, the tubes 4 are manufactured, preferably by extrusion. Two dies are used here: a die with a roughly rectangular cross-section for any intermediate tubes 4i; and a die with a “D” cross-section for the two end tubes 4e. A tank 1 requires two end tubes 4e and “n” intermediate tubes 4i, where “n” is a positive integer and can be zero. In a second step, each tube 4, 4e, 4i is surrounded by a filament-wound elementary structure 2e, reproducing its cross-sectional shape. In a third step, tubes 4, 4i, 4e, fitted with their elementary structure 2e, are assembled, with their X axes parallel, in the final configuration of the tank 1. In a fourth step, an end shell 5, 6 is welded to each end of the tubes 4 to seal the volume of the tank 1. This assembly is preferably carried out by inserting an intermediate piece 7, 8 between the tubes 4 and shells 5, 6. Once the tubes 4 and end shells 5, 6 have been assembled, a fifth step creates an overall structure 2g by filament winding.

The disclosure has been illustrated and described in detail in the drawings and the preceding description. This must be considered as illustrative and given by way of example and not as limiting the disclosure to this description alone. Many alternative embodiments are possible.

### LIST OF REFERENCE SIGNS

1: tank,
2: structure,
2e: elementary structure,
2g: overall structure,
3: liner,
4: tube,
4th: end tube,
4i: intermediate tube,
5, 6: end shell,
7, 8: intermediate piece.

1. A tank for pressurized gas comprising:
a composite structure;
a liner that comprises at least two parallel tubes extending substantially along a first direction from first tube ends to second tube ends; and
a first common end shell at the first tube ends and a second common end shell at the second tube ends, wherein the first and the second common end shells sealingly close all tubes of the at least two parallel tubes, and in that the composite structure comprises an elementary structure around each tube of the at least two parallel tubes, and an overall structure around an assembly of the at least two parallel tubes and the first and the second common end shells.

2. The tank, according to claim 1, where the at least two parallel tubes are produced by extrusion.

3. The tank according to claim 1, where the first and the second common end shells are injection-molded.

4. The tank according to claim 1, wherein the first and the second common end shells are assembled to the first tube ends and the second tube ends by welding.

5. The tank according to claim 1, wherein the elementary structure is produced by filament winding around each tube of the at least two parallel tubes and/or the overall structure is produced by filament winding around the assembly of the at least two parallel tubes and the first and the second common end shells.

6. The tank according to claim 1, wherein the liner further comprises an intermediate piece taking a shape of a cross-section of the assembly of the at least two parallel tubes, wherein the intermediate piece is inserted and welded between the first and the second tube ends and the first and the second common end shells.

7. The tank according to claim 1, wherein at least one of the at least two parallel tubes comprises an end tube that has a partially circular cross-section.

8. The tank according to claim 7, wherein the end tube has a substantially “D-shaped” cross-section.

9. The tank according to claim 1, wherein the at least two parallel tubes comprise at least a first end tube, a second end tube, and an intermediate tube positioned between the first end tube and the second end tube, and wherein the intermediate tube has an oblong cross-section.

10. The tank according to claim 9, wherein the intermediate tube has rectangular cross-section with rounded corners.

11. A method for manufacturing a tank for pressurized gas, the tank comprising a composite structure and a liner, the method including the following steps:
manufacturing a plurality of tubes by extrusion, the plurality of tubes comprising two end tubes and at least zero intermediate tubes;
creating an elementary structure around each tube of the plurality of tubes by filament winding;
parallel assembling of the plurality of tubes;
welding an end shell to each tube end of the plurality of tubes; and
creating an overall structure around an assembly of the plurality of tubes and end shells by filament winding.

12. The method according to claim 11, wherein welding of the end shell to each tube end is accomplished by inserting an intermediate piece.
